(19) United States
(12) Patent Application Publication
(10) Pub. No.: US 2002/0144999 A1
(43) Pub. Date: Oct. 10, 2002

(54) Refrigerant container for automobile

(76) Inventor: Kuen-Hsien Lu, Chang-hua (TW)

Correspondence Address: RAVIN & BERDO, P. C., 1101 14TH STREET, N.W., SUITE 500, WASHINGTON, DC, 20005, US

(21) Appl. No.: 09/835,526

(22) Filed: Apr. 17, 2001

(30) Foreign Application Priority Data
Apr. 4, 2001 (TW) 90205194

(51) Int. Cl. F17C 1/00

(52) U.S. Cl. 220/581

(57) ABSTRACT

A refrigerant container in an automobile comprises a cover; a plurality of equally spaced connectors having inner threads integrally formed on the periphery of the cover, each of the connectors being blocked by a fastener threadedly secured thereto; and a base secured to the cover; wherein one or more of the fasteners are replaceable by the same number of mating connectors and the bore of one mating connector is made different from that of the other.

### FIELD OF THE INVENTION

The present invention relates to refrigerant containers and more particularly to a refrigerant container for automobile with improved characteristics.

### BACKGROUND OF THE INVENTION

A conventional refrigerant container A in an automobile is shown in FIGS. 1A and 1B. Container A comprises a cover A1 and a base A2 welded together. A plurality of spaced openings are formed on the periphery of container A. Then the same number of connectors A3 having inner threads are welded to respective openings in welded points A5 However, the previous design suffered from several disadvantages. For example, the welded points A5 are unsightly Further, the size of connector A3 and the bore of opening are required to be conformed relative to each other in order to obtain a snug fit around the joining peripheral surface A4 therebetween. Otherwise, the securing between connector A3 and opening is not reliable even there are welded together by the welded point A5. Furthermore, the welding process is tedious and a high precision is required. Both inevitably lowers the manufacturing efficiency. Moreover, the number and positions of connectors A3 in a refrigerant container of one type of automobile are different from that of another type of automobile as best illustrated in FIGS. 1A, 1C and 1D. This further adversely affects the manufacturing efficiency and increases the manufacturing cost.

### SUMMARY OF THE INVENTION

It is therefore an object of the present invention to provide a refrigerant container in an automobile comprising a cover; a plurality of equally spaced connectors having inner threads integrally formed on the periphery of the cover, each of the connectors being blocked by a fastener threadedly secured thereto; and a base secured to the cover; wherein one or more of the fasteners are replaceable by the same number of mating connectors and the bore of one mating connector is different from that of the other.

The above and other objects, features and advantages of the present invention will become apparent from the following detailed description taken with the accompanying drawings.

### BRIEF DESCRIPTION OF THE DRAWINGS

FIG. 1A is a perspective view of a conventional refrigerant container for automobile;

FIG. 1B is a sectional view of FIG. 1A;

FIG. 1C is a perspective view of another conventional refrigerant container for automobile;

FIG. 1D is a perspective view of still another conventional refrigerant container for automobile;

FIG. 2 is an exploded view of a first preferred embodiment of refrigerant container for automobile according to the invention;

FIG. 3 is a longitudinal sectional view of FIG. 2;

FIG. 4 is a transverse sectional view of FIG. 2;

FIG. 5 is a perspective view of a second preferred embodiment of refrigerant container for automobile according to the invention;

FIG. 6 is a view similar to FIG. 4 illustrating one configuration of connectors in which connectors are projected outwardly; and

FIG. 7 is a view similar to FIG. 4 illustrating another configuration of connectors in which connectors are projected inwardly.

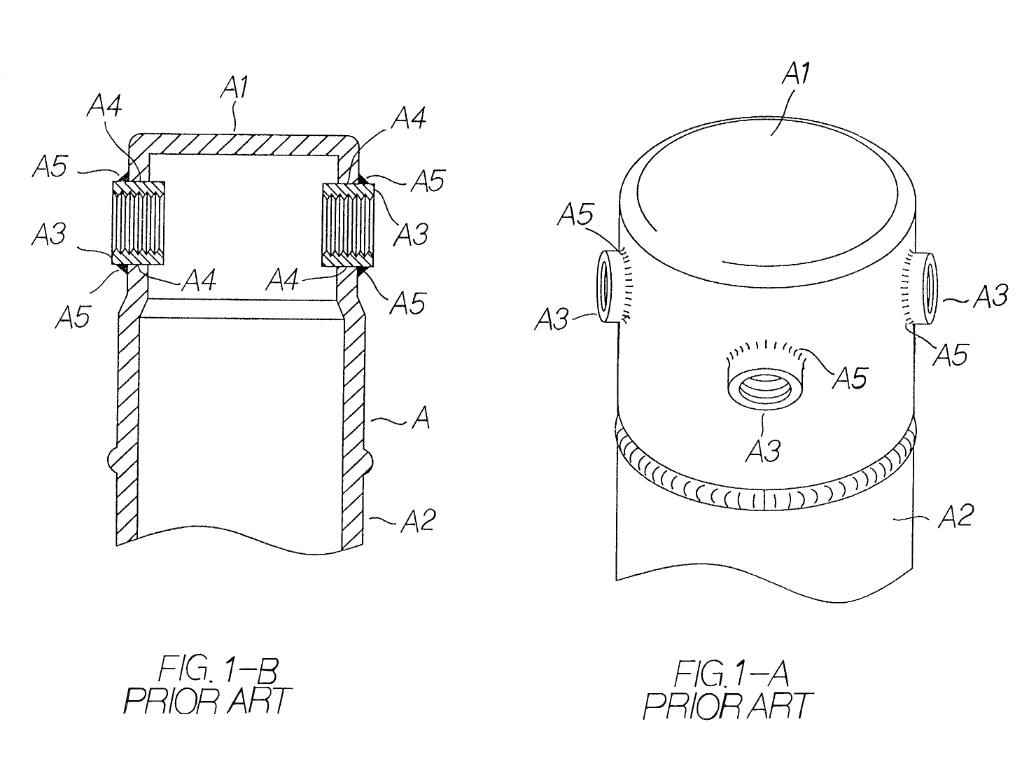

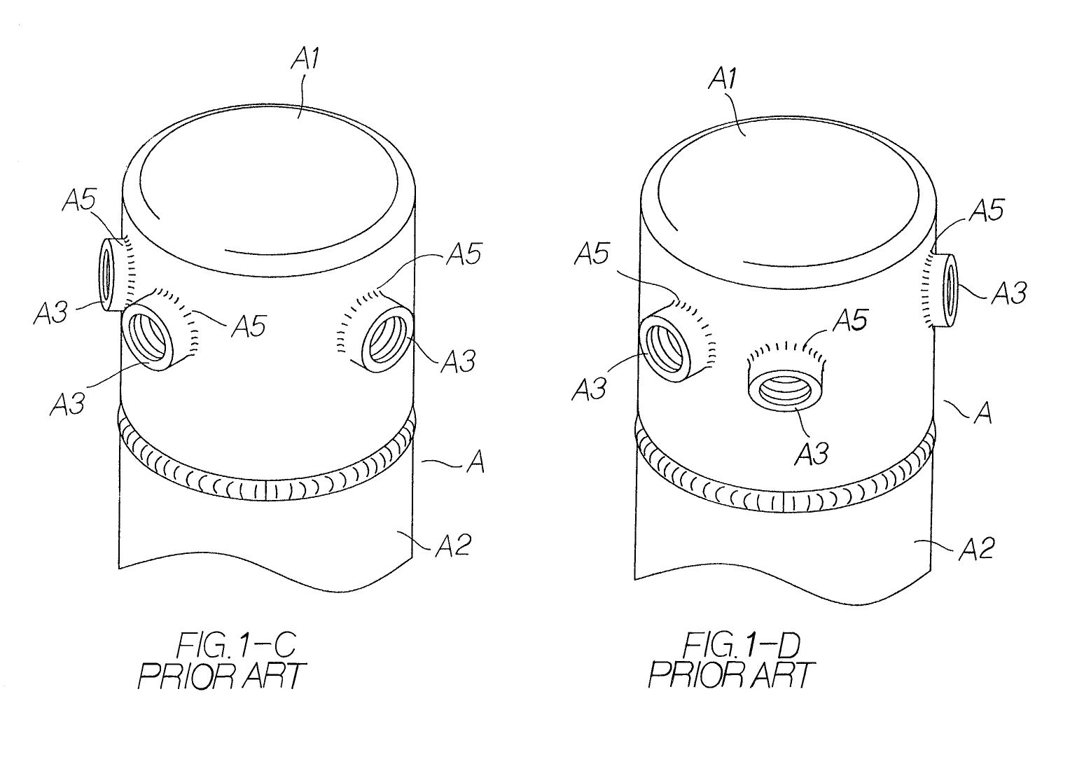

### DETAILED DESCRIPTION OF THE PREFERRED EMBODIMENTS

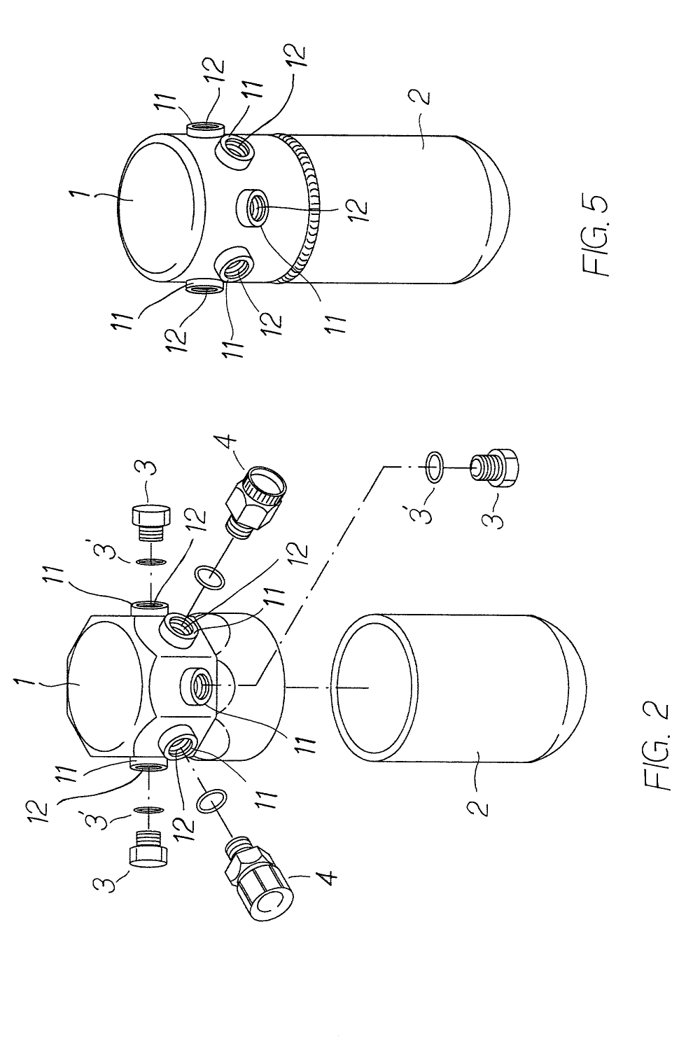

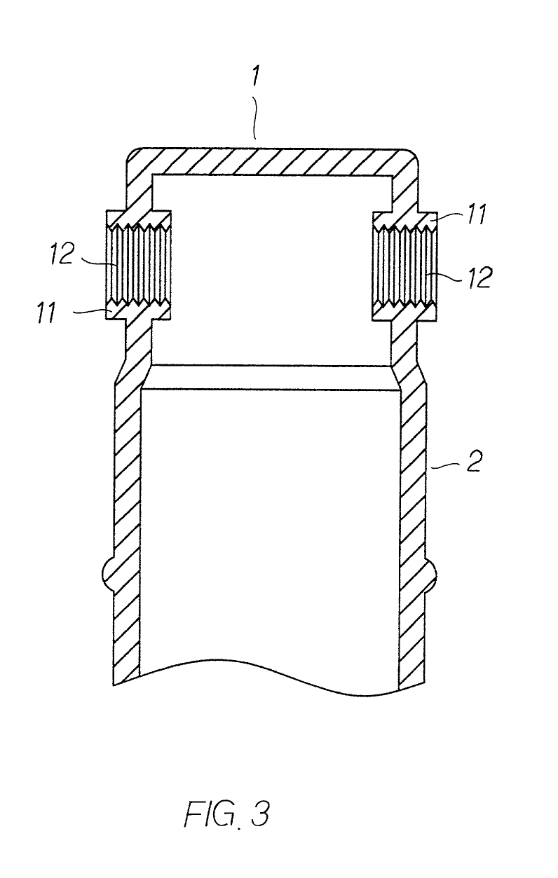

Referring to FIGS. 2, 3 and 4, there is shown a first preferred embodiment of refrigerant container for automobile in accordance with the invention comprising a cover 1 a plurality of equally spaced connectors 11 having inner threads 12 integrally formed on the periphery of cover 1, and a base 2 welded to the cover 1. After manufactured, all connectors 11 are blocked by bolts 3 which are driven hru washers 3′ to threadedly secure to the connectors 11. In use, user may replace one or more bolts 3 by the same number of mating connectors 4 depending on applications. The bore of one mating connector 4 may be designed as different from that of the other one so as to be adapted to various flow rates of refrigerant. Hence, a plurality of advantages are obtained by the invention. For example, the appearance is preserved. The welding between connector and opening is eliminated. As a result, the manufacturing efficiency is improved and thus the manufacturing cost is reduced.

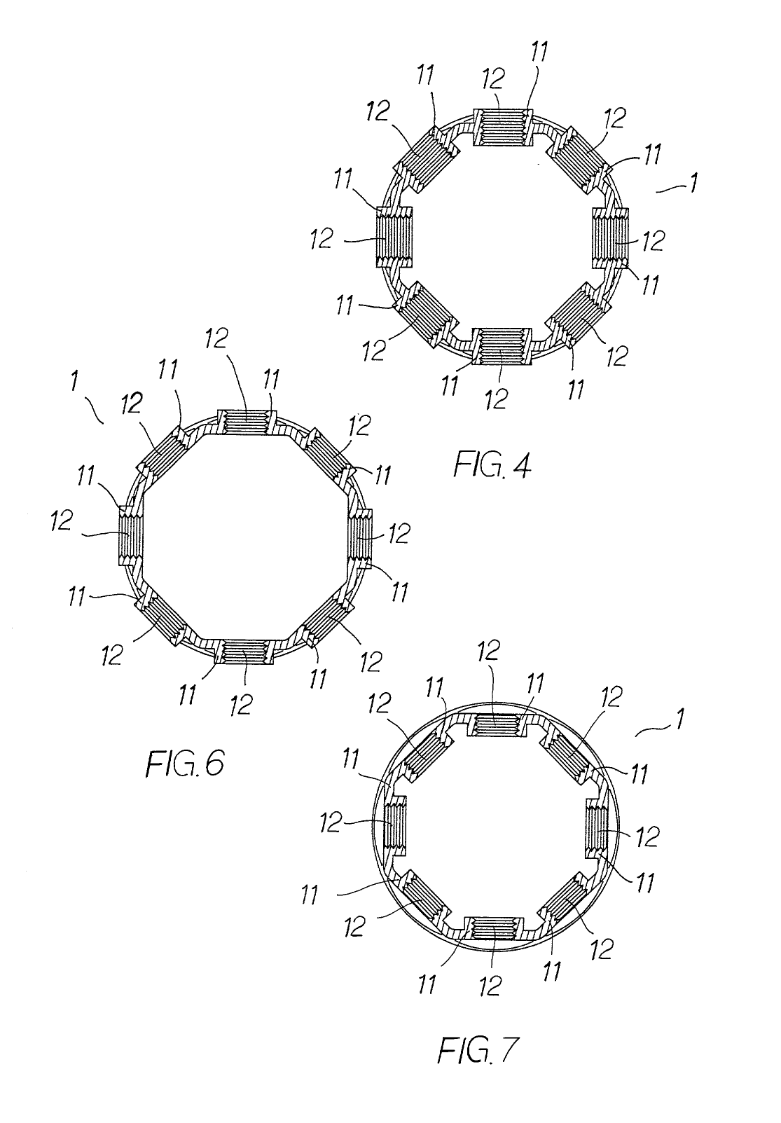

It is designed that there are many configurations made possible by the invention. For example, the cover 1 may be an octagon (see FIG. 2) or a circle (see FIG. 5) wherein eight connectors 11 are formed on cover 1 in either case. Further, connectors 11 may be projected both inwardly and outwardly (see FIG. 4) only outwardly (see FIG. 6), or only inwardly (see FIG. 7) with respect to the surface of cover 1.

While the invention has been described by means of specific embodiments, numerous modifications and variations could be made thereto by those skilled in the art without departing from the scope and spirit of the invention set forth in the claims.

What is claimed is:

1. A refrigerant container in an automobile comprising:
a cover;
a plurality of equally spaced connectors having inner threads integrally formed on said periphery of said cover, each of said connectors being blocked by a fastener threadedly secured thereto; and
a base secured to said cover,
wherein one or more of said fasteners are replaceable by said same number of mating connectors.

2. The refrigerant container of claim 1, wherein said bore of one mating connector is different from that of said other.

3. The refrigerant container of claim 1, wherein said cover is an octagon with one connector in each side thereof.

4. The refrigerant container of claim 1, wherein said cover is a circle.

5. The refrigerant container of claim 1, wherein each connector is projected both inwardly and outwardly with respect to said surface of said cover.

6. The refrigerant container of claim 1, wherein each connector is projected inwardly with respect to said surface of said cover.

7. The refrigerant container of claim 1, wherein each connector is projected outwardly with respect to said surface of said cover.
